(19) United States
(12) Patent Application Publication
(10) Pub. No.: US 2026/0322622 A1
(43) Pub. Date: Oct. 15, 2026

(54) SECURE COMPUTER NETWORK COMMUNICATIONS BASED ON MULTI-PARTY SIGNATURES

(71) Applicant: ISLAND TECHNOLOGY INC., DALLAS, TX (US)

(72) Inventors: DAN AMIGA, RAMAT HASHARON (IL); LIRON ZUARETS, TEL AVIV (IL); RON DALAL, TEL AVIV (IL); AVIV ALANKRI, TEL AVIV (IL)

(21) Appl. No.: 19/647,930

(22) Filed: Apr. 15, 2026

Related U.S. Application Data
(60) Provisional application No. 63/788,840, filed on Apr. 15, 2025.

(51) Int. Cl. H04L 9/32; H04L 9/08; H04L 9/30; H04L 9/40

(52) U.S. Cl. CPC H04L 9/3247; H04L 9/0825; H04L 9/30; H04L 9/3213; H04L 9/40

(57) ABSTRACT

A computer security method including receiving a request transmitted from a client computer via a computer network, the request including a first token and a second token, the first token identifying a user of a computer software application hosted by the client computer, the second token identifying the client computer, where the first token and the second token are issued by a second computer that is other than the client computer, determining, using a public key associated with the client computer, that a signature of the request is valid, determining, using a public key associated with the second computer, that a signature of the first token is valid, determining, using the public key associated with the second computer, that a signature of the second token is valid, and granting the client computer with access to a target computer responsive to determining that all of the signatures are valid.

### FIELD

The invention relates generally to computer security.

### BACKGROUND

Enterprise environments necessitate stringent security controls to protect sensitive information and internal resources. Traditional remote access solutions, while facilitating connectivity to protected resources, often lack the ability to authenticate the specific tools or applications initiating the connection, relying instead solely on user authentication. This gap in security mechanisms allows potential malicious actors to bypass controls introduced by the browser, by utilizing non-browser tools to mimic legitimate access requests.

### SUMMARY

In one aspect of the invention a computer security method is provided including receiving a request that is transmitted from a client computer via a computer network, where the request includes a first token and a second token, where the first token identifies a user of a computer software application hosted by the client computer, where the second token identifies the client computer, and where the first token and the second token are issued by a second computer that is other than the client computer, determining, using a public key associated with the client computer, that a signature of the request is valid, determining, using a public key associated with the second computer, that a signature of the first token is valid, determining, using the public key associated with the second computer, that a signature of the second token is valid, and granting the client computer with access to a target computer responsive to determining that all of the signatures are valid.

In another aspect of the invention the first token is issued after the user, when using the computer software application at the client computer, is authenticated at an identity provider, after the identity provider sends to the computer software application a Security Assertion Markup Language (SAML) response that includes user information identifying the user, whereupon the computer software application forwards the SAML response to the second computer, and after the second computer determines that the SAML response is valid and extracts the user information from the SAML response.

In another aspect of the invention the first token includes the user information and is signed using a private key associated with the second computer.

In another aspect of the invention the second token is issued after the client computer receives a deployment key from the second computer, validates a signature of the deployment key, and provides to the second computer a verification request including the deployment key and a machine identifier that uniquely identifies the client computer, and after the second computer determines, using the public key associated with the client computer, that a signature of the verification request is valid.

In another aspect of the invention the second token includes the machine identifier and is signed using a private key associated with the second computer.

In another aspect of the invention the second token is issued after the client computer generates a device attestation object, signs the device attestation object using a private key that corresponds to the public key associated with the client computer, and transmits the signed device attestation object to the second computer whereupon the signed device attestation object is validated, after the client computer provides to the second computer a verification request including the signed device attestation object and a machine identifier that uniquely identifies the client computer, and after the second computer determines, using the public key associated with the client computer, that a signature of the verification request is valid and that the signed device attestation object is valid.

### BRIEF DESCRIPTION OF THE DRAWINGS

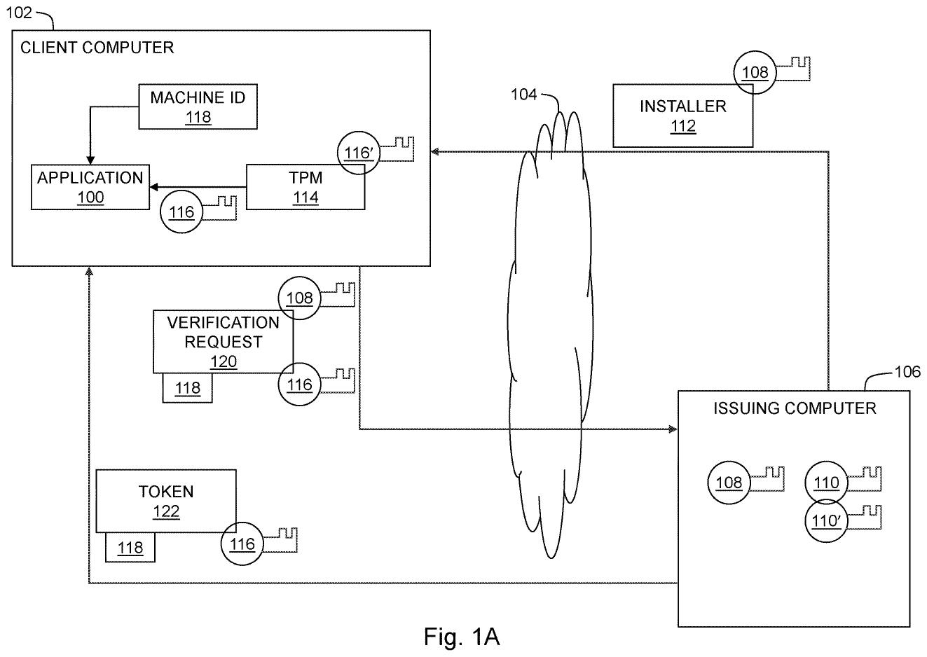

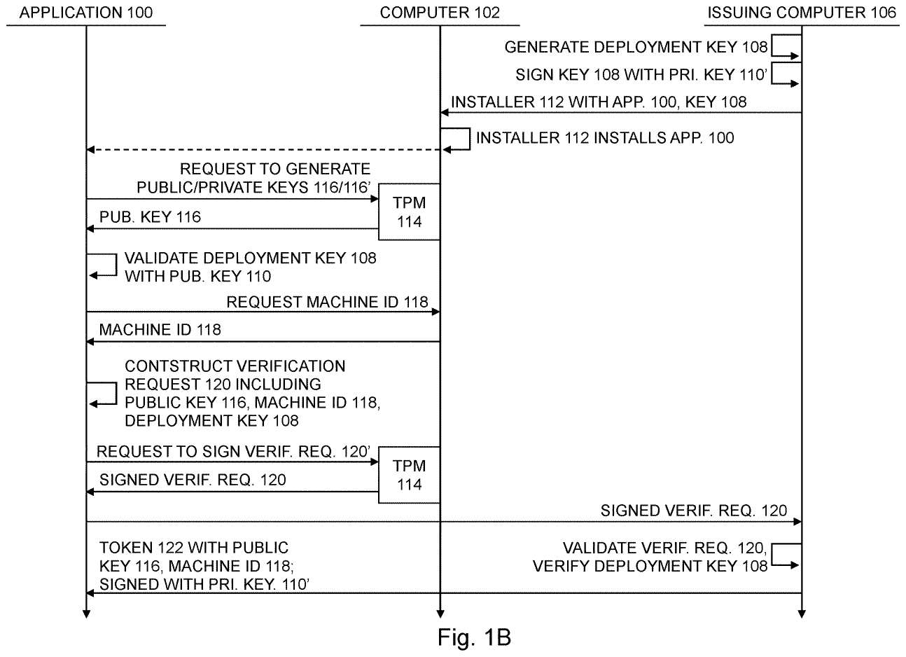

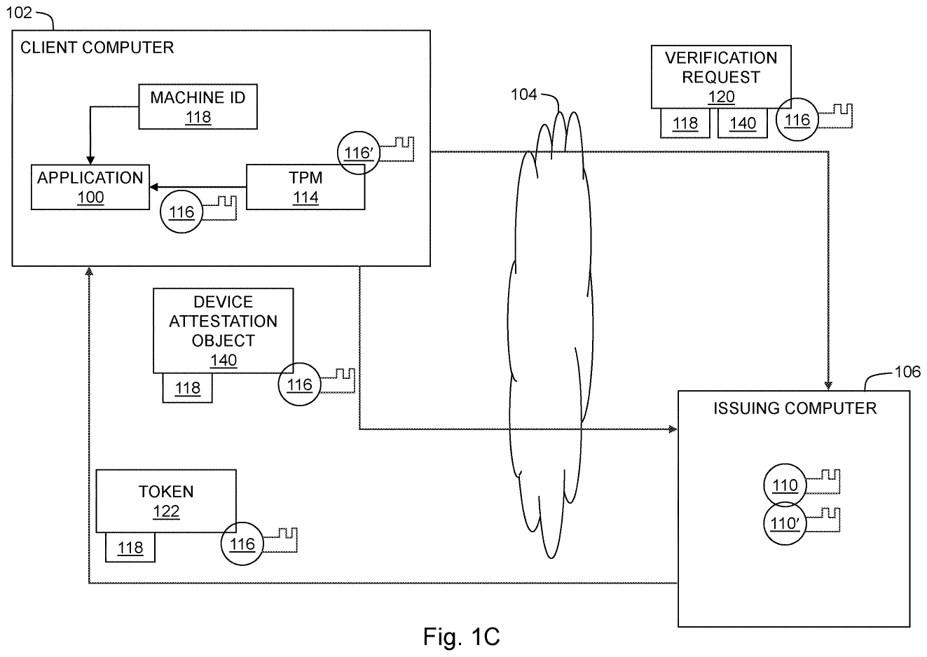

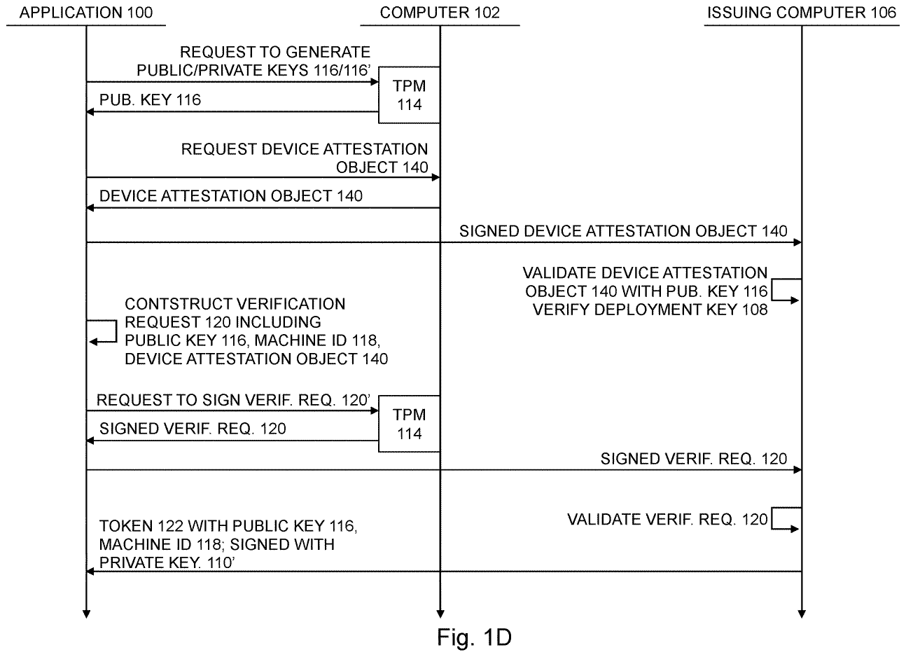

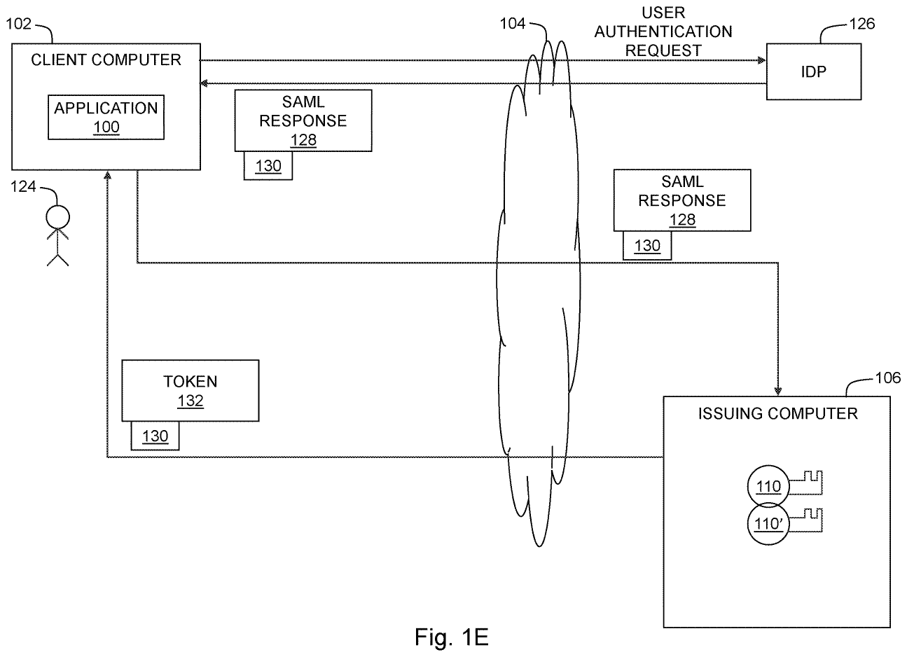

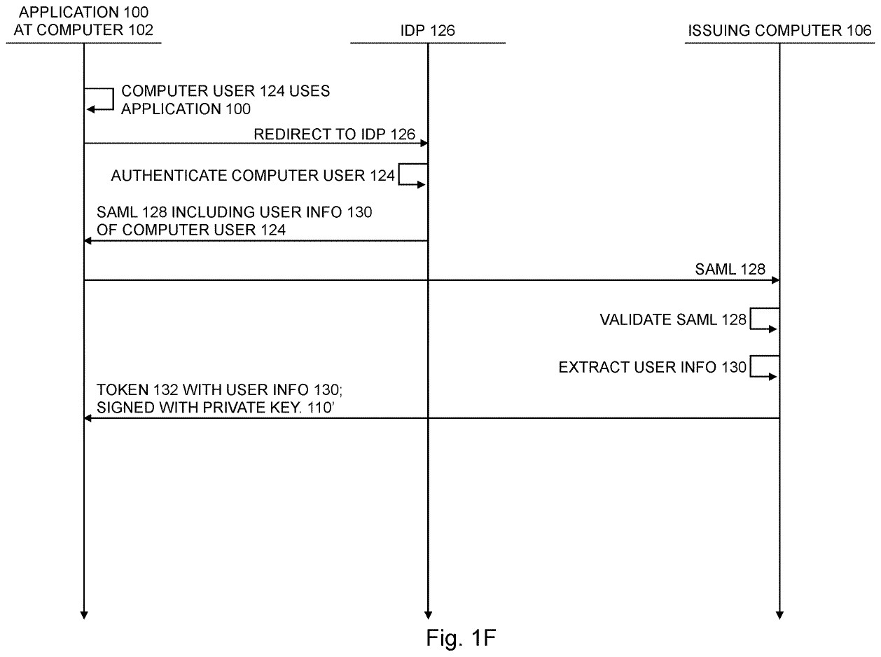

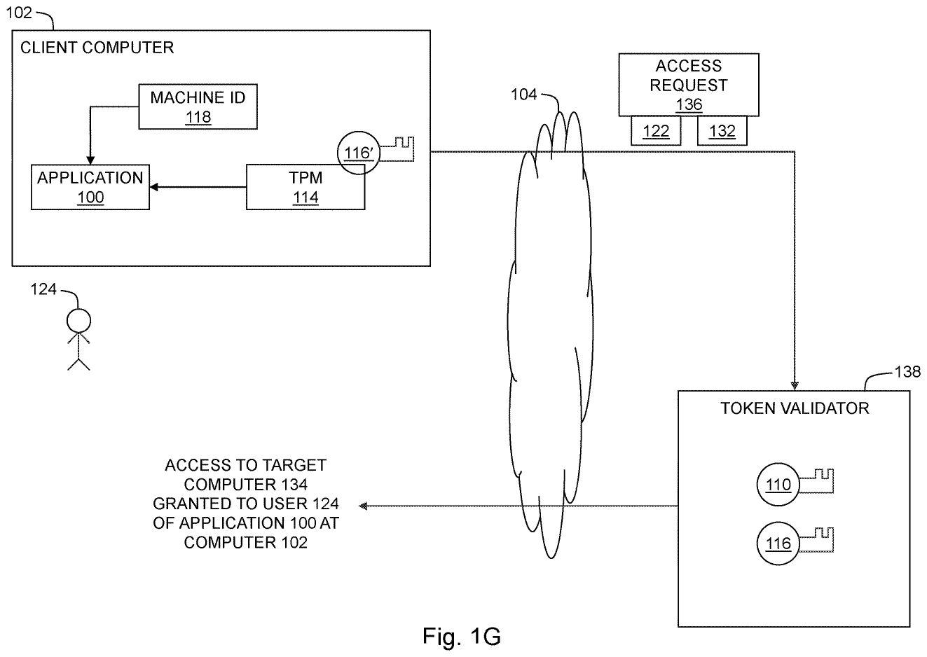

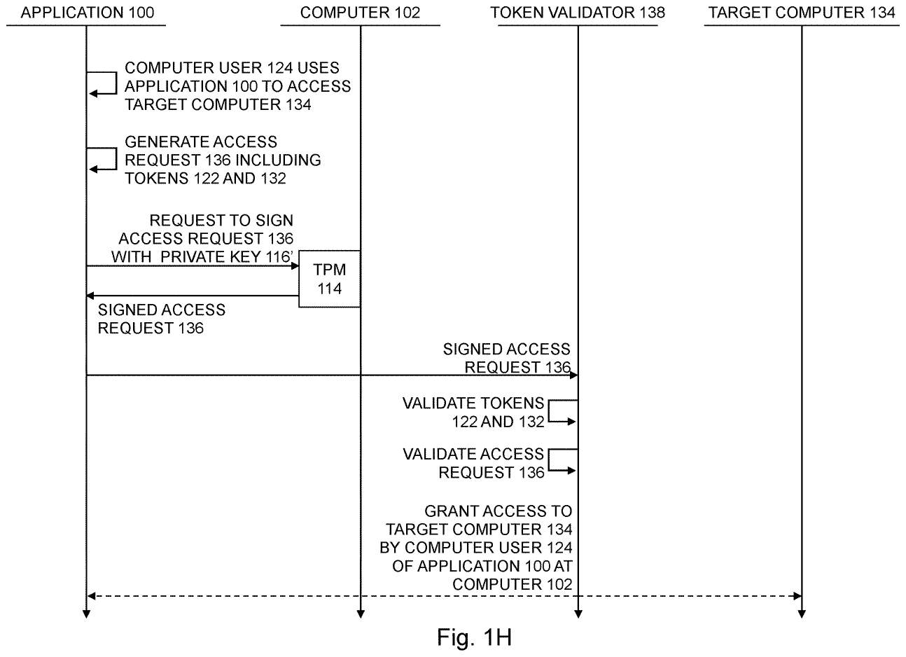

Aspects of the invention will be understood and appreciated more fully from the following detailed description taken in conjunction with the appended drawings in which FIGS. 1A-1H, taken together, is a simplified conceptual illustration of a computer security system and methods of operation therefor, constructed and operative in accordance with embodiments of the invention.

### DETAILED DESCRIPTION

Reference is now made to FIGS. 1A-1H, which, taken together, is a simplified conceptual illustration of a computer security system and methods of operation therefor, constructed and operative in accordance with embodiments of the invention. Referring more particularly to FIGS. 1A and 1B, a computer software application 100, also referred to herein as application 100, is configured to be hosted by a computer 102, also referred to herein as client computer 102, that is connected to a computer network 104, which may, for example, be the Internet or a corporate intranet that provides access to one or more other computer networks, such as the Internet. In one embodiment application 100 is a web browser that is configured to incorporate the functionality of conventional web browsers, such as those based on the Google™ Chromium™ architecture, and that in an additional embodiment is configured to operate as is described in U.S. patent application Ser. Nos. 17/740,457 and 17/993,919.

A computer 106, also referred to herein as issuing computer 106, is configured to generate and store a unique deployment key 108, such as a random string of 16 or more characters, where deployment key 108 is preferably uniquely associated with an organization or a group of computer users, often referred to as a “tenant.” In one embodiment deployment key 108 is signed, in accordance with conventional techniques, using a private key 110′ that is stored by issuing computer 106 and that has a corresponding public key 110 that is made publicly available. Signed deployment key 108 is then provided in a configuration file that is packaged together with a computer software installer 112 that is configured to install application 100 onto client computer 102 and that is provided to client computer 102. Upon installation of application 100 onto client computer 102 by computer software installer 112, or thereafter during a secure initialization process, application 100 issues a request to a Trusted Platform Module (TPM) 114 of client computer 102 to generate a public/private key pair 116/116′, in accordance with conventional techniques, where TPM 114 securely stores private key 116′, and where public key 116 is made publicly available. Application 100 also obtains deployment key 108 from the configuration file that was packaged with computer software installer 112 and preferably validates the signature of deployment key 108 using public key 110 of issuing computer 106 in accordance with conventional techniques.

Application 100 obtains from client computer 102 a machine identifier 118 that uniquely identifies client computer 102, such as by using an operating system API to request such an identifier or by deriving machine identifier 118 based on information otherwise obtainable from client computer 102, such as by hashing a serial number or other device-unique identifier exposed by the client computer 102 operating system, such as a BIOS UUIDENTIFIER.

Application 100 constructs a verification request 120 that preferably includes public key 116, machine identifier 118, and deployment key 108. Application 100 issues a request to TPM 114 to sign verification request 120 using private key 116′ and transmits signed verification request 120 to issuing computer 106 via computer network 104. Issuing computer 106 validates signed verification request 120 using public key 116 and verifies that deployment key 108 from verification request 120 matches deployment key 108 stored by issuing computer 106. Upon successful verification of verification request 120, issuing computer 106 issues a token 122, such as a JSON Web Token (JWT), that identifies client computer 102 by including public key 116 and machine identifier 118 from verification request 120. Issuing computer 106 then signs token 122 with its private key 110′ and provides signed token 122 via computer network 104 to application 100 at client computer 102.

FIGS. 1C-1D represent an alternative embodiment of the invention with respect to that which is shown in FIGS. 1A-1B. In FIGS. 1C and 1D, application 100 issues a request to TPM 114 of client computer 102 to generate public/private key pair 116/116′, in accordance with conventional techniques, where TPM 114 securely stores private key 116′, and where public key 116 is made publicly available. Application 100 then obtains from client computer 102 a device attestation object (DAO) 140, such as in accordance with the Automated Certificate Management Environment (ACME) protocol, where DAO 140 includes, or is otherwise cryptographically bound to, public key 116 and machine identifier 118, and is signed by private key 116′. Application 100 transmits signed DAO 140 to issuing computer 106 via computer network 104, where issuing computer 106 validates the signature of DAO 140 using public key 116. Alternatively, signed DAO 140 is forwarded to a validation server (not shown) acting on behalf of issuing computer 106, which validates and provides validated DAO 140 to issuing computer 106.

Application 100 thereafter constructs verification request 120 that preferably includes public key 116, machine identifier 118, and DAO 140, issues a request to TPM 114 to sign verification request 120 using private key 116′, and transmits signed verification request 120 to issuing computer 106 via computer network 104. Issuing computer 106 validates signed verification request 120 using public key 116 and validates DAO 140 in accordance with the protocol used to create DAO 140. Alternatively, signed DAO 140 is forwarded to a validation server (not shown) acting on behalf of issuing computer 106, which performs the aforementioned validation and provides validated DAO 140 to issuing computer 106. Upon successful verification of verification request 120, issuing computer 106 issues a token 122, such as a JSON Web Token (JWT), that identifies client computer 102 by including public key 116 and machine identifier 118 from verification request 120. Issuing computer 106 then signs token 122 with its private key 110′ and provides signed token 122 via computer network 104 to application 100 at client computer 102.

Referring more particularly to FIGS. 1E and 1F, when a computer user 124 first begins using application 100 at client computer 102, and preferably periodically thereafter in accordance with a predefined policy, application 100 redirects the user to an Identity Provider (IDP) 126, such as Okta™ or EntraID™, via computer network 104, where IDP 126 has been preconfigured with information necessary for authenticating computer user 124, such as a username, password, and multi-factor authentication (MFA) information associated with computer user 124. After IDP 126 successfully authenticates computer user 124 in accordance with conventional techniques, IDP 126 sends to application 100 a signed Security Assertion Markup Language (SAML) response 128 that includes user information 130 associated with computer user 124, such as user ID, email address, and group memberships. Application 100 forwards signed SAML response 128 to issuing computer 106 which then validates the signature of signed SAML response 128 in accordance with conventional techniques and, upon successful validation, extracts user information 130 associated with computer user 124. Issuing computer 106 then issues a token 132, such as a JSON Web Token (JWT), that identifies computer user 124 by including the extracted user information 130. Issuing computer 106 then signs token 132 with its private key 110′ and provides signed token 132 via computer network 104 to application 100 at client computer 102. Alternatively, signed SAML response 128 may be forwarded to a SAML authentication server (not shown) acting on behalf of issuing computer 106, which performs the aforementioned validation and extraction, issues token 132, signs token 132 with its own private key, and provides token 132 to issuing computer 106 or directly to application 100 at client computer 102.

Referring more particularly to FIGS. 1G and 1H, when computer user 124 attempts to use application 100 at client computer 102 to access a computer 134, also referred to herein as target computer 134, via computer network 104, application 100 generates a request 136, also referred to herein as access request 136, to access target computer 134, where access request 136 includes token 122 and token 132. Application 100 issues a request to TPM 114 to sign access request 136 or a portion thereof using private key 116′ and transmits signed access request 136 via computer network 104 to a token validator 138, which may be target computer 134 or a separate validation server or proxy acting on behalf of target computer 134. Token validator 138 validates the signatures of token 122 and token 132 using public key 110, extracts public key 116 from validated token 122, and validates the signature of access request 136 using public key 116. After the signatures of token 122, token 132, and access request 136 have been validated, computer user 124 of application 100 at client computer 102 is granted access to target computer 134. In various embodiments application 100 provides access request 136 when computer user 124 first attempts to use application 100 to access target computer 134 and preferably periodically thereafter in accordance with a predefined policy, or each time computer user 124 uses application 100 to access target computer 134. Likewise, in various embodiments the recipient of access request 136 validates the signatures of token 122, token 132, and access request 136 the first time they are sent by application 100 at client computer 102 and preferably periodically thereafter in accordance with a predefined policy, or each time token 122, token 132, and access request 136 are sent by application 100 at client computer 102. In addition to what is described herein, the attempts described herein to access computer 134 and the granting of such access described herein are preferably performed in accordance with any known protocol suitable therefor, such as in accordance with Hypertext Transfer Protocol Secure (HTTPS) or any known remote access protocol such as Remote Desktop Protocols (RDP) in support of Virtual Private Networks (VPNs) and Zero Trust Network Access (ZTNA) protocols.

The invention, in embodiments thereof, thus provides for granting a user of an application at a client computer with access to a target computer only after 1) validating a signed access request that is sent by the client computer using a public key that is associated with the client computer, 2) validating a signed user-identifying token included in the access request using a public key that is associated with a token issuer that is a party other than the client computer, and 3) validating a signed client-computer-identifying token included in the access request using the public key of the token issuer.

Any aspect of the invention described herein may be implemented in computer hardware and/or computer software embodied in a non-transitory, computer-readable medium in accordance with conventional techniques, the computer hardware including one or more computer processors, computer memories, I/O devices, and network interfaces that interoperate in accordance with conventional techniques.

It is to be appreciated that the term “processor” or “device” as used herein is intended to include any processing device, such as, for example, one that includes a CPU (central processing unit) and/or other processing circuitry. It is also to be understood that the term “processor” or “device” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to activity illustrations and/or block diagrams of methods, apparatus (systems), and computer program products according to embodiments of the invention. It will be understood that each element of the activity illustrations and/or block diagrams, and combinations of elements in the activity illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the activity illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the activity illustrations and/or block diagrams.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the activity illustrations and/or block diagrams.

Activity illustrations, block diagrams, and actions shown in the drawing figures illustrate the architecture, functionality, and operation of possible implementations of systems, methods, and computer program products according to various embodiments of the invention. In this regard, each element of the activity illustrations or block diagrams may represent a module, segment, or portion of computer instructions, which comprises one or more executable computer instructions for implementing the specified logical function(s). In some alternative implementations, the functions noted in an element may occur out of the order noted in the drawing figures. For example, two elements shown in succession may, in fact, be executed substantially concurrently, or the elements may sometimes be executed in the reverse order, depending upon the functionality involved. It will also be noted that each element of the activity illustrations and block diagrams, and combinations of such elements, can be implemented by special-purpose hardware-based and/or software-based systems that perform the specified functions or acts.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments.

What is claimed is:

1. A computer security method comprising:
receiving a request that is transmitted from a client computer via a computer network,
wherein the request includes a first token and a second token,
wherein the first token identifies a user of a computer software application hosted by the client computer,
wherein the second token identifies the client computer, and
wherein the first token and the second token are issued by a second computer that is other than the client computer;
determining, using a public key associated with the client computer, that a signature of the request is valid;
determining, using a public key associated with the second computer, that a signature of the first token is valid;
determining, using the public key associated with the second computer, that a signature of the second token is valid; and
granting the client computer with access to a target computer responsive to determining that all of the signatures are valid.

2. The computer security method according to claim 1 wherein the first token is issued
after the user, when using the computer software application at the client computer, is authenticated at an identity provider,
after the identity provider sends to the computer software application a Security Assertion Markup Language (SAML) response that includes user information identifying the user, whereupon the computer software application forwards the SAML response to the second computer, and
after the second computer determines that the SAML response is valid and extracts the user information from the SAML response.

3. The computer security method according to claim 2 wherein the first token includes the user information and is signed using a private key associated with the second computer.

4. The computer security method according to claim 1 wherein the second token is issued
after the client computer receives a deployment key from the second computer, validates a signature of the deployment key, and provides to the second computer a verification request including the deployment key and a machine identifier that uniquely identifies the client computer, and
after the second computer determines, using the public key associated with the client computer, that a signature of the verification request is valid.

5. The computer security method according to claim 4 wherein the second token includes the machine identifier and is signed using a private key associated with the second computer.

6. The computer security method according to claim 1 wherein the second token is issued
after the client computer generates a device attestation object, signs the device attestation object using a private key that corresponds to the public key associated with the client computer, and transmits the signed device attestation object to the second computer whereupon the signed device attestation object is validated,
after the client computer provides to the second computer a verification request including the signed device attestation object and a machine identifier that uniquely identifies the client computer, and
after the second computer determines, using the public key associated with the client computer, that a signature of the verification request is valid and that the signed device attestation object is valid.

7. The computer security method according to claim 6 wherein the second token includes the machine identifier and is signed using a private key associated with the second computer.
